(19) United States
(12) Patent Application Publication
(10) Pub. No.: US 2002/0196252 A1
(43) Pub. Date: Dec. 26, 2002

(54) Method and apparatus for rendering three-dimensional images with tile-based visibility preprocessing

(76) Inventors: Min-Hao Liao, Hsin-Chu City (TW); Kwo-Woei Yet, Miaoli Hsien (TW)

Correspondence Address: Ladas & Parry, Suite 1200, 224 South Michigan Avenue, Chicago, IL, 60604, US

(21) Appl. No.: 09/885,147

(22) Filed: Jun. 20, 2001

(51) Int. Cl. G06T 15/40

(52) U.S. Cl. 345/422

(57) ABSTRACT

When rendering a three-dimensional image, which is modeled from interconnected polygons, on a display area, a visibility preprocessor determines a visibility status for each of the polygons that can be projected onto a projection plane of a selected part of the display area. Based on the visibility status of the polygons, a Coarse-Z testing circuit can skip those polygons that are concluded to be hidden, and performs a Coarse-Z test for those polygons that are not concluded to be hidden. A graphics rendering circuit is controlled by the Coarse-Z testing circuit to render the polygons, which are concluded to be currently and completely visible during the Coarse-Z test thereof. A Z-testing circuit is controlled by the Coarse-Z testing circuit to perform a Z-test for those polygons whose status is indeterminate, and controls the graphics rendering circuit so as to render points which are concluded to be visible during the Z-test.

### BACKGROUND OF THE INVENTION

1. Field of the Invention

The invention relates to a method and apparatus for rendering three-dimensional images, more particularly to a method and apparatus for rendering three-dimensional images with tile-based visibility preprocessing.

2. Description of the Related Art

In a graphics rendering system for rendering three-dimensional images, the surface of an object in a scene is modeled using several interconnected rectangular or triangular polygons. The rendering process typically begins by transforming the polygons to obtain position and display parameter data in preparation for a subsequent rasterizing process. During the rasterizing process, the values of pixels in a viewing space are computed based on the parameter data of the polygons that can be projected onto or that cover the pixels.

In any given three-dimensional graphics scene, a number of the polygons can be projected onto the same area of a projection plane. As such, some of the polygons overlap and are thus not visible in the scene. Accordingly, data computations made in connection with hidden polygons result in a waste of time and in inefficient utilization of memory and bandwidth resources.

In order to solve the aforesaid problem, hidden surface removal algorithms have been proposed heretofore for removing overlapping facets among objects that are projected onto a projection plane. A well-known algorithm of the above-mentioned type is the Z-buffer algorithm or Z-test, which uses a Z-buffer for storing the depth value of each pixel of the projection plane. The kernel of the Z-buffer algorithm involves a depth comparison mechanism between the depth value of each point of the projected polygon and the corresponding pixel depth value stored in the Z-buffer. According to the depth comparison result, the Z-buffer is updated with the smaller depth value. Therefore, the Z-buffer can reflect the smallest depth value encountered for each pixel in the projection plane. As a result, the points that are visible can be determined, and those that are hidden can be eliminated.

In the aforesaid Z-test, the depth values of the points of the projected polygons are compared with the pixel depth values in the Z-buffer to determine visible and hidden points on the projection plane. For a four-pixel-pipeline graphics rendering system operating at 150 MHz working frequency, the required memory bandwidth for reading a 32-bit Z-buffer thereof is more than 2 gigabytes per second. It is evident that graphics rendering performance will suffer from bottleneck due to the large memory bandwidth requirement.

In order to overcome the above-stated drawback that is associated with the Z-test process, a Coarse-Z test (or tile-based Z-test) has been proposed heretofore to reduce the required memory bandwidth when determining visibility. FIGS. 1 and 2 illustrate a Coarse-Z test process as performed in the prior art. As shown in FIG. 1, a display area is divided into a plurality of equally sized tiles (m, n), each of which is subjected to the Coarse-Z test. First and second triangles (T1, T2) can be projected onto a number of the tiles (m, n). The first and second triangles (T1, T2) overlap in part, and the first triangle (T1) is disposed in the foreground with respect to the second triangle (T2). In the Coarse-Z test, each tile (m, n) has a corresponding Coarse-Z buffer (m, n) for storing a smallest Z-value that is associated with the respective tile (m, n). Each Coarse-Z buffer (m, n) has an initial value of 1.0 stored therein, corresponding to a background depth. In the example of FIG. 2, the tile (7, 4) is subjected to the Coarse-Z test process. In addition, the first triangle (T1) is assumed to have minimum and maximum Z-values of 0.2 and 0.4, respectively, with respect to the tile (7, 4), whereas the second triangle (T2) is assumed to have minimum and maximum z-values of 0.6 and 0.9, respectively, with respect to the tile (7, 4). When testing the visibility of the first triangle (T1) within the tile (7, 4), the Z-value stored in the corresponding Coarse-Z buffer (7, 4) is accessed and is compared with the Z-values of the first triangle (T1) within the tile (7, 4). Since the maximum Z-value of the first triangle (T1) within the tile (7, 4), i.e. 0.4, is less than the initial background depth value, i.e. 1.0, that is stored in the corresponding Coarse-Z buffer (7, 4), the first triangle (T1) is determined to be in the foreground with respect to the background position, and the Z-value in the corresponding Coarse-Z buffer (7, 4) will be updated with the minimum Z-value of the first triangle (T1) within the tile (7, 4), i.e. 0.2. This indicates that the first triangle T1 is currently visible, and a pixel-by-pixel visibility test or Z-test for points in the first triangle T1 need not be performed at this time. Thereafter, the visibility of the second triangle (T2) within the tile (7, 4) is tested. Since the Z-value stored in the corresponding Coarse-Z buffer (7, 4), i.e. 0.2, is less than the Z-values of the second triangle (T2) within the tile (7, 4), the second triangle (T2) is determined to be in the background with respect to the first triangle (T1), and is thus not visible. The Z-value in the corresponding Coarse-Z buffer (7, 4) will be maintained at 0.2. Therefore, there is no need to perform a Z-test for the points of the second triangle (T2) within the tile (7, 4).

The required memory bandwidth for the Coarse-Z test is smaller than that for the Z-test. For example, with a display size of 1024×768 pixels, if the tiles are 32×32 pixels in size, only 768 elements are required to be stored in the Coarse-Z buffer, thereby resulting in a very small memory bandwidth requirement. However, when a large number of polygons overlap on a selected tile of the display area, and only one of the polygons is visible on the selected tile, unnecessary computations will occur, thereby resulting in waste of memory resources.

### SUMMARY OF THE INVENTION

Therefore, the main object of the present invention is to provide a method and apparatus for rendering three-dimensional images with tile-based visibility preprocessing so as to overcome the aforesaid drawbacks that are associated with both Z-test and Coarse-Z test.

According to one aspect of the invention, there is provided a method for rendering a three-dimensional image on a display area, the image being modeled from interconnected polygons. The method comprises the steps of:

performing visibility preprocessing to determine a visibility status for each of the polygons that can be projected onto a projection plane of a selected part of the display area; and

performing image rendering for each of the polygons that can be projected onto the projection plane, including

inspecting the visibility status of each of the polygons,

skipping the polygons that are concluded to be hidden based on the visibility status thereof,

performing a Coarse-Z test for each of the polygons that are not concluded to be hidden based on the visibility status thereof,

skipping the polygons that are concluded to be completely hidden during the Coarse-Z test thereof,

rendering the polygons, which are concluded to be currently and completely visible during the Coarse-Z test thereof, within the selected part of the display area,

performing a Z-test for each of the polygons that are not concluded to be completely hidden nor completely visible during the Coarse-Z test thereof,

skipping points on the polygons that are concluded to be hidden during the Z-test, and

rendering points on the polygons, which are concluded to be visible during the Z-test, within the selected part of the display area.

According to another aspect of the invention, there is provided an apparatus for rendering a three-dimensional image on a display area, the image being modeled from interconnected polygons. The apparatus comprises a visibility preprocessor and an image rendering device.

The visibility preprocessor determines a visibility status for each of the polygons that can be projected onto a projection plane of a selected part of the display area.

The image rendering device includes an inspecting circuit, a Coarse-Z testing circuit, a graphics rendering circuit, and a Z-testing circuit.

The inspecting circuit, which is connected to the visibility preprocessor, inspects the visibility status of each of the polygons that can be projected onto the projection plane. The Coarse-Z testing circuit is connected to and controlled by the inspecting circuit so as to skip the polygons that are concluded to be hidden based on the visibility status thereof, and so as to perform a Coarse-Z test for each of the polygons that are not concluded to be hidden based on the visibility status thereof. The graphics rendering circuit is connected to and controlled by the Coarse-Z testing circuit so as to skip the polygons that are concluded to be completely hidden during the Coarse-Z test thereof, and so as to render the polygons, which are concluded to be currently and completely visible during the Coarse-Z test thereof, within the selected part of the display area. The Z-testing circuit is connected to and controlled by the Coarse-Z testing circuit so as to perform a Z-test for each of the polygons that are not concluded to be completely hidden nor completely visible during the Coarse-Z test thereof. The Z-testing circuit is further connected to and controls the graphics rendering circuit so as to skip points on the polygons that are concluded to be hidden during the Z-test, and so as to render points on the polygons, which are concluded to be visible during the Z-test, within the selected part of the display area.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a display area divided into a number of tiles that are selected to undergo a conventional Coarse-Z test;

FIG. 2 illustrates depth values of two triangles on the display area of FIG. 1;

FIG. 3 is a flowchart illustrating a visibility preprocessing procedure of the preferred embodiment of a method for rendering a three-dimensional image in accordance with the present invention;

FIG. 4 is a flowchart illustrating an image rendering procedure of the method of the preferred embodiment;

FIG. 5 is a schematic circuit block diagram illustrating a visibility preprocessor of the preferred embodiment of an apparatus for rendering a three-dimensional image in accordance with the present invention;

FIG. 6 shows a display area divided into a number of tiles to help illustrate the operation of the visibility preprocessor of FIG. 5;

FIG. 7 is an exemplary process flow diagram to illustrate how the visibility preprocessor operates to process first, second and third triangles on the display area of FIG. 6; and

FIG. 8 is a schematic circuit block diagram illustrating an image rendering device of the apparatus of the preferred embodiment.

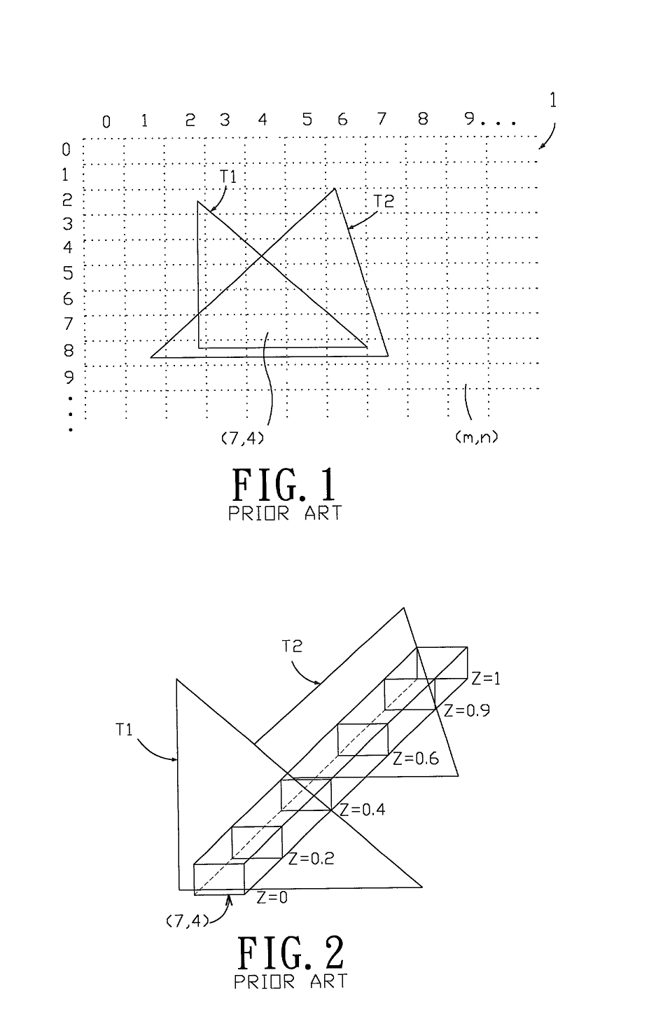

### DETAILED DESCRIPTION OF THE PREFERRED EMBODIMENT

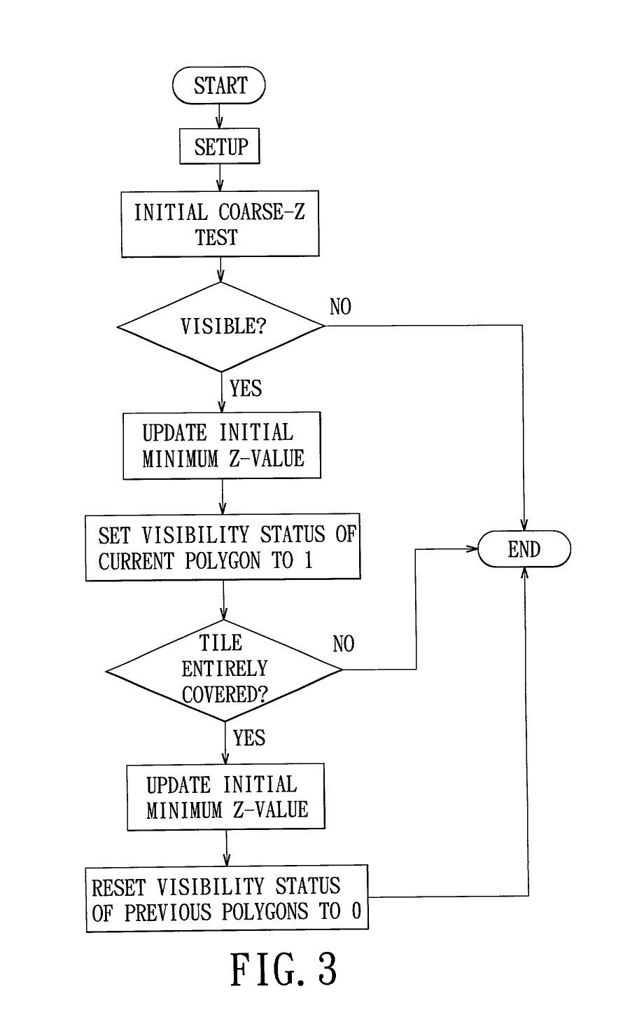

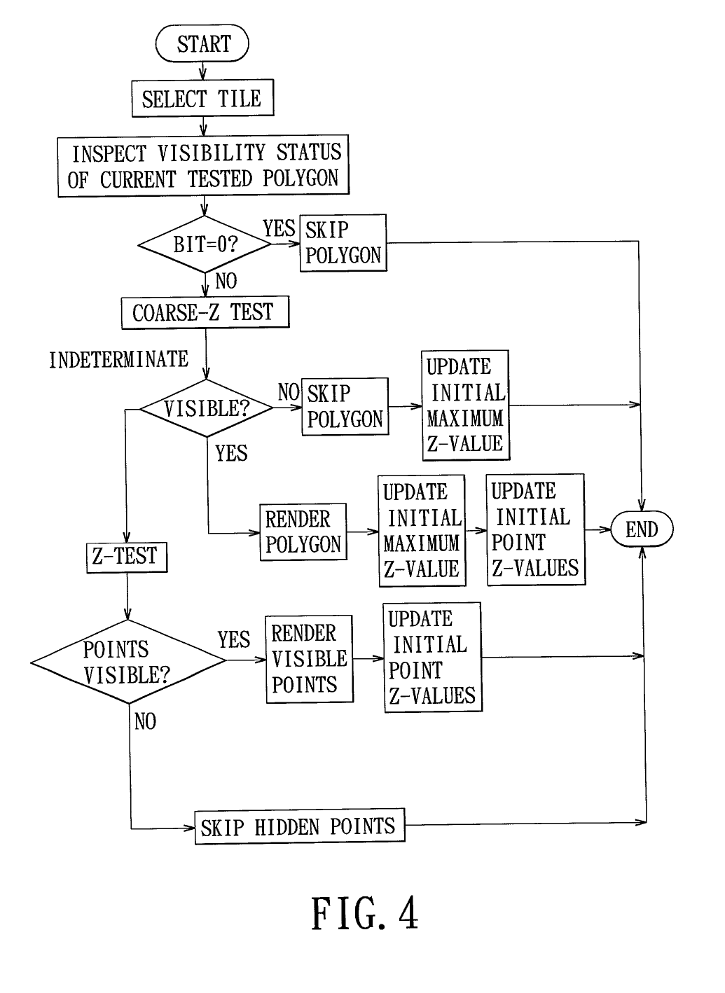

The preferred embodiment of a method for rendering three-dimensional images on a display area according to the present invention comprises a visibility preprocessing procedure (see FIG. 3) and an image rendering procedure (see FIG. 4).

With reference to FIG. 3, during a setup stage of the visibility preprocessing procedure, a display area is divided into a plurality of equally sized tiles (m, n), each of which can be the target of a visibility preprocessing test. Each of the tiles (m, n) is associated with a Coarse-Z buffer (m, n), a visibility buffer (m, n), and a counter (m, n). The counter (m, n) and all elements of the visibility buffer (m, n) are initialized with zero. In addition, each pixel of the display area is associated with an element of a pixel Z-buffer. The position parameters of the polygons that are projected onto a number of the tiles (m, n) are also determined during the setup stage.

The visibility preprocessing procedure further includes an initial Coarse-Z test, where one of the tiles (m, n) is selected for testing. Prior to the Coarse-Z test, the Coarse-Z buffer (m, n) that is associated with the selected tile (m, n) has initial minimum and maximum Z-values stored therein. The initial minimum and maximum Z-values are set to a maximum value of 1.0, which corresponds to the background depth. During the initial Coarse-Z test, the minimum and maximum point Z-values of each of the polygons that can be projected onto the selected tile (m, n) are determined. The counter (m, n) that is associated with the selected tile (m, n) stores a count number corresponding to the number of the polygons that can be projected onto the selected tile (m, n). The minimum and maximum point Z-values of the polygons are compared with the initial minimum and maximum Z-values in the Coarse-Z buffer (m, n). When the maximum point Z-value of a projected one of the polygons is smaller than the initial minimum Z-value in the Coarse-Z buffer (m, n), this indicates that the projected polygon is currently visible, and the minimum point Z-value of the projected polygon is used to update the initial minimum Z-value in the Coarse-Z buffer (m, n). Moreover, a visibility bit in the visibility buffer (m, n), indicative of the visibility status of the projected polygon, is set to 1. In addition to the condition that the maximum point Z-value of the projected polygon is smaller than the initial minimum Z-value in the Coarse-Z buffer (m, n), when the projected polygon if found to cover the selected tile (m, n) entirely such that the previous projected polygons are hidden by the same, the maximum point Z-value of the projected polygon is used to update the initial maximum Z-value in the Coarse-Z buffer (m, n).At the time, the visibility bits of the previous projected polygons are reset to 0. The contents of the visibility buffer (m, n) are accessed during the subsequent image rendering procedure.

With reference to FIG. 4, during the image rendering procedure, when one of the tiles (m, n) is selected, the polygons are projected onto the tiles (m, n) so as to be tested in sequence in accordance with the count output of a second counter (m, n) that is associated with the selected one of the tiles (m, n). According to the count output of the second counter (m, n), a corresponding visibility bit in the visibility buffer (m, n) is read to inspect the visibility status of the current tested polygon within the selected tile (m, n) If the visibility bit is 0, this indicates that the current tested polygon is concluded to be hidden, and the current tested polygon is skipped so as not to render the same. If the visibility bit is 1, this indicates that the current tested polygon may or may not be visible within the selected tile (m, n). A Coarse-Z test is performed for the current tested polygon within the selected tile (m, n) at this time. During the Coarse-Z test, the minimum and maximum point-Z values of the current tested polygon are compared with the initial minimum and maximum Z-values stored in a second Coarse-Z buffer (m, n) that is associated with the selected tile (m, n). If the minimum point Z-value of the current tested polygon is larger than the initial maximum Z-value stored in the second Coarse-Z buffer (m, n), this indicates that the current tested polygon is concluded to be completely hidden within the selected tile (m, n), and the current tested polygon is skipped so as not to render the same. In addition, the maximum point Z-value of the current tested polygon is used to update the initial maximum Z-value in the second Coarse-Z buffer (m, n). If the maximum point Z-value of the current tested polygon is smaller than the initial minimum Z-value stored in the second Coarse-Z buffer (m, n), this indicates that the current tested polygon is currently and completely visible within the selected tile (m, n), and the current tested polygon is rendered within the selected tile (m, n). Under this condition, the minimum and maximum point Z-values of the current tested polygon are used to update the initial minimum and maximum Z-values in the second Coarse-Z buffer (m, n), and the point Z-values of the current tested polygon are used to update initial point Z-values in a pixel Z-buffer (m, n) corresponding to the selected tile (m, n).

Polygons that are not concluded to be completely hidden nor completely visible within the selected tile (m, n) during the Coarse-Z test undergo a Z-test. In other words, the Z-test is performed only when the status of the current tested polygon is still indeterminate after the Coarse-Z test.

The Z-test proceeds in a manner generally similar to that in the prior art. During the Z-test, the point Z-values of the current tested polygon within the selected tile (m, n) are compared with the initial point Z-values in the pixel Z-buffer (m, n). A hidden set of points on the current tested polygon consists of those points having the point Z-values thereof greater than the corresponding ones of the initial point-Z values in the pixel Z-buffer (m, n). The hidden set of points is skipped so as not to render the same. A visible set of the points on the current tested polygon consists of those points having the point Z-values thereof smaller than the corresponding ones of the initial point-Z values in the pixel Z-buffer (m, n). The visible set of the points is rendered, and the point Z-values of the visible set of the points are used to update the corresponding initial point Z-values in the pixel Z-buffer (m, n).

Therefore, during the visibility preprocessing procedure, it is possible to identify some of the projected polygons that are not visible on the selected tile. Thereafter, during the image rendering procedure, by referring to the contents of the visibility buffer, the Coarse-Z test can further eliminate polygons that are not visible on the selected tile so that rendering of the polygons that are concluded to be completely visible can proceed. Finally, the Z-test is performed for those polygons whose status is indeterminate. Since Z-test is performed only for a small number of the polygons whose status is indeterminate, the memory bandwidth requirement can be dramatically reduced, and the number of complex calculations can be reduced as well to thereby improve the graphics rendering efficiency.

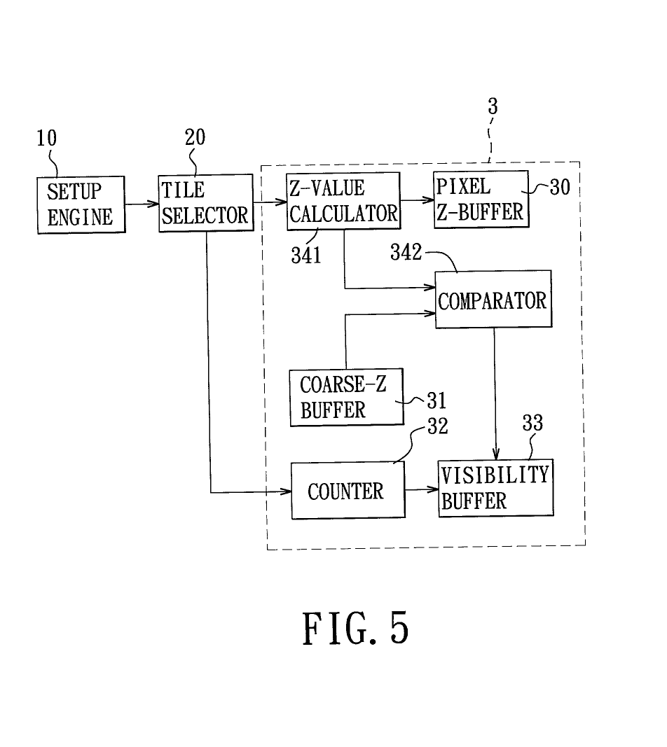

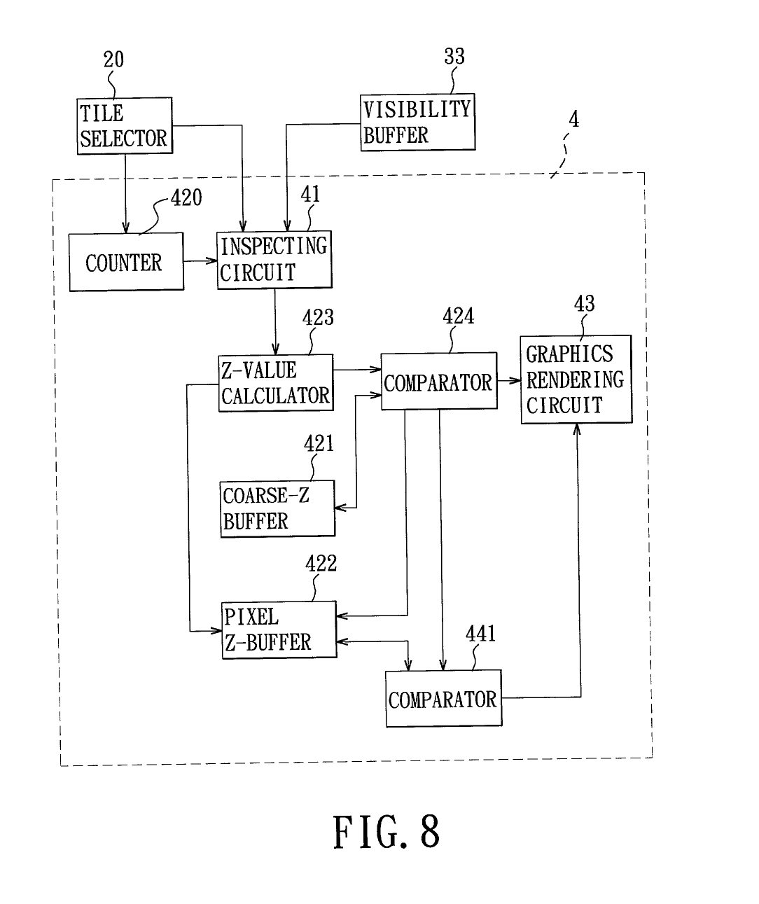

The preferred embodiment of an apparatus for rendering three-dimensional images on a display area according to the present invention comprises a visibility preprocessor 3 (see FIG. 5) and an image rendering device 4 (see FIG. 8). The image is modeled from interconnected polygons, and the display area is divided into a number of equally-sized tiles.

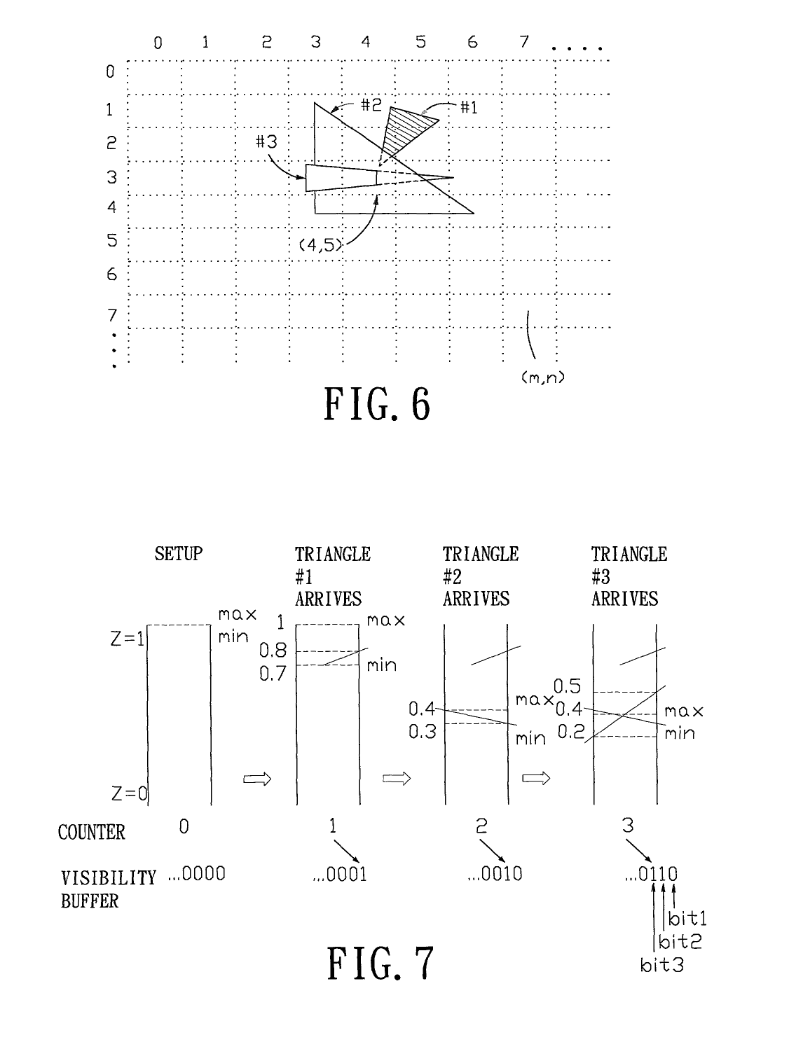

Referring to FIG. 5, a setup engine 10 is responsible for determining the position parameters of the polygons that can be projected onto the tiles of the display area. A tile selector 20 is connected to the setup engine 10 and is used to select one of the tiles of the display area. The visibility preprocessor 3 is connected to the tile selector 20, and is used to determine a visibility status for each of the polygons that can be projected onto a projection plane of the selected tile. The visibility preprocessor 3 includes a pixel Z-buffer 30, a Coarse-Z buffer 31, a counter 32 and a visibility buffer 33, which are all associated with the selected tile, and an initial Coarse-Z testing circuit including a Z-value calculator 341 and a comparator 342. The operation of the visibility preprocessor 3 will now be described in greater detail with further reference to FIGS. 6 and 7.

In FIGS. 6 and 7, the tile (4, 5) is selected and, assuming that the Z-values range from 0 to 1, the Coarse-Z buffer 31 has minimum and maximum Z-values of 1.0 initially stored therein. As illustrated in FIGS. 6 and 7, first, second and third triangles #1, #2, #3 can be projected onto the selected tile (4, 5). When the count output of the counter 32 is 1, the first triangle #1 is projected onto the selected tile (4, 5). The Z-value calculator 341 calculates the Z-values for the points of the first triangle #1 within the selected tile (4, 5), and stores the same in the pixel Z-buffer 30. Thereafter, the minimum and maximum point Z-values of the first triangle #1 within the selected tile (4, 5) are determined by the Z-value calculator 341 from the contents of the pixel Z-buffer 30. Assuming that the minimum and maximum point Z-values of the first triangle #1 within the selected tile (4, 5) are 0.7 and 0.8, respectively, these values are sent by the Z-value calculator 341 to the comparator 342. The comparator 342 compares the minimum and maximum point Z-values for the first triangle #1 within the selected tile (4, 5) with the initial minimum and maximum Z-values that are stored in the Coarse-Z buffer 31. Since the maximum point Z-value of the first triangle #1 within the selected tile (4, 5), i.e. 0.8, is smaller than the initial maximum Z-value of 1.0 stored in the Coarse-Z buffer 31, the minimum point Z-value of the first triangle #1 within the selected tile (4, 5), i.e. 0.7, will be used to update the initial minimum Z-value of 1.0 in the Coarse-Z buffer 31. Moreover, because the count output of the counter 32 is 1, a visibility bit which corresponds to the first triangle #1 and which is found in the visibility buffer 33 will be set to 1. However, because the first triangle #1 only covers a portion of the selected tile (4, 5), the maximum point Z-value thereof will not necessarily be the maximum Z-value that will be found for the selected tile (4, 5). As such, the initial maximum Z-value for the selected tile (4, 5) will not be updated at this time.

When the second triangle #2 is projected onto the selected tile (4, 5), the count output of the counter is 2. The Z-value calculator 341 calculates the point Z-values of the second triangle #2 within the selected tile (4, 5), and stores the same in the pixel Z-buffer 30. Thereafter, the minimum and maximum point Z-values of the second triangle #2 within the selected tile (4, 5) are determined from the contents of the pixel Z-buffer 30. Assuming that the minimum and maximum point Z-values of the second triangle #2 within the selected tile (4, 5) are 0.3 and 0.4, respectively, these values are sent by the Z-value calculator 341 to the comparator 342. The comparator 342 compares the minimum and maximum point Z-values of the second triangle #2 within the selected tile (4, 5) with the initial minimum and maximum Z-values that are stored in the Coarse-Z buffer 31. Since the maximum point Z-value of the second triangle #2 within the selected tile (4, 5), i.e. 0.4, is less than the initial minimum Z-value of 0.7 stored in the Coarse-Z buffer 31, it can be concluded that the second triangle #2 is disposed in front of the first triangle #1, and is not covered by the same. As such, the minimum point Z-value of the second triangle #2 within the selected tile (4, 5), i.e. 0.3, will be used to update the initial minimum Z-value stored in the Coarse-Z buffer 31. In addition, because the second triangle #2 covers the entire tile (4, 5), the maximum point Z-value of the second triangle #2 within the selected tile (4, 5), i.e. 0.4, will be used to update the initial maximum Z-value stored in the Coarse-Z buffer 31. Moreover, because the count output of the counter 32 is 2, a visibility bit which corresponds to the second triangle #2 and which is found in the visibility buffer 33 will be set to 1, whereas the visibility bit which corresponds to the first triangle #1 will be reset to 0, thereby indicating that the first triangle #1 will be hidden by the second triangle #2.

When the third triangle #2 is projected onto the selected tile (4, 5), the count output of the counter is 3. The Z-value calculator 341 calculates the Z-values for the points of the third triangle #2 within the selected tile (4, 5), and stores the same in the pixel Z-buffer 30. Thereafter, the minimum and maximum point Z-values for the third triangle #2 within the selected tile (4, 5) are determined from the contents of the pixel Z-buffer 30. Assuming that the minimum and maximum point Z-values of the third triangle #2 within the selected tile (4, 5) are 0.2 and 0.5, respectively, these values are sent by the Z-value calculator 341 to the comparator 342. The comparator 342 compares the minimum and maximum point Z-values of the third triangle #2 within the selected tile (4, 5) with the initial minimum and maximum Z-values that are stored in the Coarse-Z buffer 31. Since the maximum point Z-value of the third triangle #2 within the selected tile (4, 5), i.e. 0.5, is greater than the initial minimum Z-value of 0.3 stored in the Coarse-Z buffer 31, but since the minimum point Z-value of the third triangle #2 within the selected tile (4, 5), i.e. 0.2, is smaller than the initial minimum Z-value of 0.3 stored in the Coarse-Z buffer 31, it can be concluded that a portion of the third triangle #2 is disposed in front of the second triangle #2, whereas a remaining portion of the third triangle #2 is disposed behind and is thus covered by the second triangle #2. The status of the third triangle #2 is deemed to be indeterminate. As such, the minimum point Z-value of the third triangle #2 within the selected tile (4, 5), i.e. 0.2, will be used to update the initial minimum Z-value stored in the Coarse-Z buffer 31. In addition, because the count output of the counter is 3, a visibility bit which corresponds to the third triangle #2 and which is found in the visibility buffer 33 will be set to 1.

From the foregoing, it is evident that, for each tile of the display area, the visibility preprocessor 3 can determine those projected polygons that are hidden, and those projected polygons that are not hidden. The status of each projected polygon is stored in the visibility buffer 33 that is associated with the selected tile for subsequent reference by the image rendering device 4 (see FIG. 8). Since only the minimum and maximum point Z-values of the polygons are compared with the contents of the Coarse-Z buffer 31 during the operation of the visibility preprocessor 3, the memory bandwidth requirement thereof is relatively small. Image rendering is not performed by the visibility preprocessor 3, but is performed instead by the image rendering device 4 (see FIG. 8), to reduce the number of complex calculations during the visibility preprocessing procedure.

Referring to FIG. 8, in combination with FIG. 7, the image rendering device 4 includes an inspecting circuit 41, a Coarse-Z testing circuit, a graphics rendering circuit 43, and a Z-testing circuit in the form of a comparator 441. The Coarse-Z testing circuit includes a counter 420, a Coarse-Z buffer 421 and a pixel Z-buffer 422 that are all associated with a selected tile of the display area, a Z-value calculator 423, and a comparator 424. In the example of FIG. 7, it is assumed that the tile (4, 5) is selected by the tile selector 20 for rendering by the image rendering device 4. When the count output of the counter 420 is 1, the first triangle #1 serves as a current tested polygon. The inspecting circuit 41 is connected to the visibility buffer 33, and inspects the visibility bit that corresponds to the first triangle #1 and that is stored in the visibility buffer 33. Since the visibility bit is 0, it is concluded that the first triangle #1 is hidden, and points of the first triangle #1 within the selected tile (4, 5) are skipped so as not to render the same. Then, when the second triangle #2 serves as the current tested polygon, the count output of the counter 420 is 2. The inspecting circuit 41 inspects the visibility bit that corresponds to the second triangle #2 and that is stored in the visibility buffer 33, and finds the visibility bit to be 1. This indicates that it has yet to be concluded whether rendering of the second triangle #2 within the selected tile (4, 5) is to be performed. At this time, the minimum and maximum point Z-values for the second triangle #2 within the selected tile (4, 5), i.e. 0.3 and 0.4, are calculated by the Z-value calculator 423, which is connected to the inspecting circuit 41 and to the comparator 424, and are sent to the comparator 424. The comparator 424 is connected to the Coarse-Z buffer 421, the graphics rendering circuit 43, and the pixel Z-buffer 422, and compares the minimum and maximum point Z-values of the second triangle #2 within the selected tile (4, 5) with the initial minimum and maximum Z-values that are stored in the Coarse-Z buffer 421. Since the maximum point Z-value of the second triangle #2 within the selected tile (4, 5), i.e. 0.4, is smaller than the initial minimum Z-value of 1.0 stored in the Coarse-Z buffer 421, it can be concluded that the second triangle #2 is currently and completely visible within the selected tile (4, 5), and point data of the second triangle #2 within the selected tile (4, 5) are sent by the comparator 424 to the graphics rendering circuit 43so as to render the same. In addition, the minimum and maximum point Z-values of the second triangle #2 within the selected tile (4, 5) will be used to update the initial minimum and maximum Z-values stored in the Coarse-Z buffer 421. Furthermore, the comparator 424 will enable the pixel Z-buffer 422 such that the Z-values for all of the points in the second triangle #2 within the selected tile (4, 5), which are received from the Z-value calculator 423, can update initial point Z-values in the pixel Z-buffer 422.

When the third triangle #2 serves as the current tested polygon, the count output of the counter 420 is 3. The inspecting circuit 41 inspects the visibility bit that corresponds to the third triangle #2 and that is stored in the visibility buffer 33, and finds the visibility bit to be 1. This indicates that it has yet to be concluded whether rendering of the third triangle #2 is to be performed. At this time, the minimum and maximum point Z-values of the third triangle #2 within the selected tile (4, 5), i.e. 0.2 and 0.5, are calculated by the Z-value calculator 423 and are sent to the comparator 424, which compares the minimum and maximum point Z-values of the third triangle #2 within the selected tile (4, 5) with the initial minimum and maximum Z-values, i.e. 0.3 and 0.4, that are stored in the Coarse-Z buffer 421. Since the minimum point Z-value of the third triangle #2 within the selected tile (4, 5), i.e. 0.2, is smaller than the initial minimum Z-value of 0.3 stored in the Coarse-Z buffer 421, but since the maximum point Z-value of the third triangle #2 within the selected tile (4, 5), i.e. 0.5, is greater than the initial maximum Z-value of 0.4 stored in the Coarse-Z buffer 421, it can be concluded that a portion of the third triangle #2 is disposed in front of the second triangle #2 and is thus visible, whereas a remaining portion of the third triangle #2 is disposed behind and is thus hidden by the second triangle #2. The status of the third triangle #2 is deemed to be indeterminate even after processing by the Coarse-Z testing circuit. Rendering of the third triangle #2 thus proceeds with the use of the Z-testing circuit.

As mentioned beforehand, the Z-testing circuit is in the form of a comparator 441, the operation of which is controlled by the comparator 424. The comparator 441 receives the Z-values for all of the points of the third triangle #2 within the selected tile (4, 5), and compares the same with corresponding initial point Z-values stored in the pixel Z-buffer 422. A hidden set of points on the third triangle #2 consists of those points having the point Z-values thereof greater than their corresponding initial point Z-values in the pixel Z-buffer 422. A visible set of the points on the third triangle #2 consists of those points having the point Z-values thereof smaller than their corresponding point Z-values in the pixel Z-buffer 422. The comparator 441 controls the graphics rendering circuit 43 for skipping the hidden set of the points and for rendering the visible set of the points. In addition, the comparator 441 updates the initial point Z-values in the pixel Z-buffer 422 with the point Z-values of the visible set of the points on the third triangle #3.

By performing the abovementioned operation on the other tiles of the display area, a complete three-dimensional image can be rendered by the image rendering device 4 on the display area.

It has thus been shown that the visibility preprocessor 3 of the apparatus of this invention can identify hidden ones of the polygons. The status of each polygon as determined by the visibility preprocessor 3 is recorded in the visibility buffer 33. By referring to the contents of the visibility buffer 33, rendering of the hidden polygons as identified in the visibility buffer 33 can be skipped by the image rendering device 4. The Coarse-Z testing circuit of the image rendering device 4 can further identify hidden ones of the polygons, so that rendering of the polygons that are concluded by the Coarse-Z testing circuit to be visible can be performed by the graphics rendering circuit 43. Those polygons, whose status is deemed to be indeterminate by the Coarse-Z testing circuit, are subsequently processed by the Z-testing circuit. As such, the number of points that need to undergo Z-test can be dramatically reduced in the method and apparatus of this invention to result in a relatively small memory bandwidth requirement and in a relatively small number of required complex calculations, thereby enhancing the graphics rendering efficiency.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for rendering a three-dimensional image on a display area, the image being modeled from interconnected polygons, said method comprising the steps of:
performing visibility preprocessing to determine a visibility status for each of the polygons that can be projected onto a projection plane of a selected part of the display area; and
performing image rendering for each of the polygons that can be projected onto the projection plane, including
inspecting the visibility status of each of the polygons,
skipping the polygons that are concluded to be hidden based on the visibility status thereof,
performing a Coarse-Z test for each of the polygons that are not concluded to be hidden based on the visibility status thereof,
skipping the polygons that are concluded to be completely hidden during the Coarse-Z test thereof,
rendering the polygons, which are concluded to be currently and completely visible during the Coarse-Z test thereof, within the selected part of the display area,
performing a Z-test for each of the polygons that are not concluded to be completely hidden nor completely visible during the Coarse-Z test thereof,
skipping points on the polygons that are concluded to be hidden during the Z-test, and
rendering points on the polygons, which are concluded to be visible during the Z-test, within the selected part of the display area.

2. The method according to claim 1, wherein the step of performing visibility preprocessing includes the sub-steps of:
storing initial minimum and maximum Z-values in a Coarse-Z buffer that corresponds to the selected part of the display area;
performing an initial Coarse-Z test for each of the polygons that can be projected onto the projection plane, including the sub-steps of
calculating minimum and maximum point Z-values for a current projected one of the polygons within the selected part of the display area, and
comparing the minimum and maximum point Z-values for the current projected one of the polygons with the initial minimum and maximum Z-values in the Coarse-Z buffer,
wherein when the maximum point Z-value for the current projected one of the polygons is smaller than the initial minimum Z-value in the Coarse-Z buffer, the initial minimum Z-value is updated with the minimum point Z-value for the current projected one of the polygons, and
wherein when the current projected one of the polygons additionally and entirely covers the selected part of the display area, the initial maximum Z-value is updated with the maximum point Z-value for the current projected one of the polygons.

3. The method according to claim 2, wherein the sub-step of performing an initial Coarse-Z test further includes the sub-steps of:
setting a visibility bit for the current projected one of the polygons in a visibility buffer that corresponds to the selected part of the display area to a first logic state when the current projected one of the polygons is found to be currently visible; and
resetting the visibility bit for a previous projected one of the polygons in the visibility buffer to a second logic state when the current projected one of the polygons is found to cover entirely the previous projected one of the polygons.

4. The method according to claim 1, wherein the sub-step of performing a Coarse-Z test includes the sub-steps of:
storing initial minimum and maximum Z-values in a Coarse-Z buffer that corresponds to the selected part of the display area;
calculating minimum and maximum point Z-values for a current tested one of the polygons within the selected part of the display area; and
comparing the minimum and maximum point Z-values for the current tested one of the polygons with the initial minimum and maximum Z-values in the Coarse-Z buffer,
wherein when the maximum point Z-value for the current tested one of the polygons is smaller than the initial minimum Z-value in the Coarse-Z buffer, the current tested one of the polygons is concluded to be currently and completely visible, the initial minimum Z-value is updated with the minimum point Z-value for the current tested one of the polygons, and initial point Z-values in a pixel Z-buffer that corresponds to the selected part of the display area are updated with point Z-values of the current tested one of the polygons within the selected part of the display area, and
wherein when the minimum point Z-value for the current tested one of the polygons is larger than the initial maximum Z-value in the Coarse-Z buffer, the current tested one of the polygons is concluded to be completely hidden, and the initial maximum Z-value is updated with the maximum point Z-value for the current tested one of the polygons.

5. The method according to claim 4, wherein the sub-step of performing a Z-test includes the step of comparing the point Z-values of the current tested one of the polygons within the selected part of the display area with the initial point Z-values in the pixel Z-buffer, wherein a hidden set of points on the current tested one of the polygons consists of those points having the point Z-values thereof greater than corresponding ones of the initial point Z-values in the pixel Z-buffer, and wherein a visible set of the points on the current tested one of the polygons consists of those points having the point Z-values thereof smaller than the corresponding ones of the initial point Z-values in the pixel Z-buffer, the point Z-values of the visible set of the points being used to update the corresponding ones of the initial point Z-values in the pixel Z-buffer.

6. The method according to claim 1, wherein the display area is divided into a number of equally-sized tiles, and one of the tiles is selected to serve as the selected part of the display area.

7. An apparatus for rendering a three-dimensional image on a display area, the image being modeled from interconnected polygons, said apparatus comprising:
a visibility preprocessor for determining a visibility status for each of the polygons that can be projected onto a projection plane of a selected part of the display area; and
an image rendering device including
an inspecting circuit, connected to said visibility preprocessor, for inspecting the visibility status of each of the polygons that can be projected onto the projection plane,
a Coarse-Z testing circuit connected to and controlled by said inspecting circuit so as to skip the polygons that are concluded to be hidden based on the visibility status thereof, and so as to perform a Coarse-Z test for each of the polygons that are not concluded to be hidden based on the visibility status thereof,
a graphics rendering circuit connected to and controlled by said Coarse-Z testing circuit so as to skip the polygons that are concluded to be completely hidden during the Coarse-Z test thereof, and so as to render the polygons, which are concluded to be currently and completely visible during the Coarse-Z test thereof, within the selected part of the display area, and
a Z-testing circuit connected to and controlled by said Coarse-Z testing circuit so as to perform a Z-test for each of the polygons that are not concluded to be completely hidden nor completely visible during the Coarse-Z test thereof, said Z-testing circuit being further connected to and controlling said graphics rendering circuit so as to skip points on the polygons that are concluded to be hidden during the Z-test, and so as to render points on the polygons, which are concluded to be visible during the Z-test, within the selected part of the display area.

8. The apparatus according to claim 7, wherein said visibility preprocessor includes:
a Coarse-Z buffer corresponding to the selected part of the display area and storing initial minimum and maximum Z-values therein; and
an initial Coarse-Z testing circuit including
a Z-value calculator for calculating minimum and maximum point Z-values for a current projected one of the polygons within the selected part of the display area, and
a comparator connected to said Coarse-Z buffer and said Z-value calculator, said comparator comparing the minimum and maximum point Z-values for the current projected one of the polygons with the initial minimum and maximum Z-values in said Coarse-Z buffer,
wherein when the maximum point Z-value for the current projected one of the polygons is smaller than the initial minimum Z-value in said Coarse-Z buffer, said comparator updates the initial minimum Z-value with the minimum point Z-value for the current projected one of the polygons, and
wherein when the current projected one of the polygons additionally and entirely covers the selected part of the display area, said comparator updates the initial maximum Z-value with the maximum point Z-value for the current projected one of the polygons.

9. The apparatus according to claim 8, wherein said initial Coarse-Z testing circuit further includes a visibility buffer corresponding to the selected part of the display area and connected to and controlled by said comparator such that a visibility bit for the current projected one of the polygons is set to a first logic state when the current projected one of the polygons is found to be currently visible, and such that the visibility bit for a previous projected one of the polygons is set to a second logic state when the current projected one of the polygons is found to cover entirely the previous projected one of the polygons.

10. The apparatus according to claim 7, wherein said Coarse-Z testing circuit includes:
a Coarse-Z buffer corresponding to the selected part of the display area and storing initial minimum and maximum Z-values therein;
a pixel Z-buffer corresponding to the selected part of the display area and storing initial point Z-values therein;
a Z-value calculator for calculating minimum and maximum point Z-values for a current tested one of the polygons within the selected part of the display area; and
a comparator connected to said Coarse-Z buffer, said pixel Z-buffer, and said Z-value calculator, said comparator comparing the minimum and maximum point Z-values for the current tested one of the polygons with the initial minimum and maximum Z-values in said Coarse-Z buffer,
wherein when the maximum point Z-value for the current tested one of the polygons is smaller than the initial minimum Z-value in said Coarse-Z buffer, the current tested one of the polygons is concluded to be currently and completely visible, and said comparator updates the initial minimum Z-value with the minimum point Z-value for the current tested one of the polygons, and further updates the initial point Z-values with point Z-values of the current tested one of the polygons within the selected part of the display area, and
wherein when the minimum point Z-value for the current tested one of the polygons is larger than the initial maximum Z-value in said Coarse-Z buffer, the current tested one of the polygons is concluded to be completely hidden, and said comparator updates the initial maximum Z-value with the maximum point Z-value for the current tested one of the polygons.

11. The apparatus according to claim 10, wherein said Z-testing circuit includes a comparator, connected to said pixel Z-buffer, for comparing the point Z-values of the current tested one of the polygons within the selected part of the display area with the initial point Z-values in said pixel Z-buffer, wherein a hidden set of points on the current tested one of the polygons consists of those points having the point Z-values thereof greater than corresponding ones of the initial point Z-values in said pixel Z-buffer, and wherein a visible set of the points on the current tested one of the polygons consists of those points having the point Z-values thereof smaller than the corresponding ones of the initial point Z-values in said pixel Z-buffer, said comparator updating the initial point Z-values in said pixel Z-buffer with the point Z-values of the visible set of the points on the current tested one of the polygons.

12. The apparatus according to claim 7, wherein the display area is divided into a number of equally-sized tiles, said apparatus further comprising a tile selector for selecting one of the tiles to serve as the selected part of the display area.
